(19) United States
(12) Patent Application Publication
(10) Pub. No.: US 2026/0348718 A1
(43) Pub. Date: Nov. 5, 2026

(54) LINEAR GUIDING DEVICE WITH AN OPTICAL LINEAR MEASURING SYSTEM

(71) Applicant: Schneeberger Holding AG, Roggwil (CH)

(72) Inventors: Simon GASSER, Olten (CH); Yves JACOB, Füllinsdorf (CH)

(73) Assignee: Schneeberger Holding AG, Roggwil (CH)

(21) Appl. No.: 19/573,283

(22) Filed: Mar. 20, 2026

(30) Foreign Application Priority Data
Apr. 30, 2025 (EP) 25173655.9

(51) Int. Cl. G01B 11/02; G01D 5/347

(52) U.S. Cl. CPC G01B 11/02; G01D 5/34753

(57) ABSTRACT

A linear guiding device includes a first linear guide body, a second linear guide body linearly movable relative to the first body, and an optical linear measuring system that includes a measurement scale with markings arranged stationarily relative to the first body, and a scanning device arranged stationarily relative to the second linear guide body for scanning the markings. The scanning device includes a light source for illuminating a measurement scale area, a light sensor for detecting the light reflected and/or scattered on the scale, and a support body for the light sensor having a passage channel for the reflected and/or scattered light. The passage channel extends between the light sensor and the measurement scale. An antireflective body has a section that extends through a segment of the passage channel and is suitable for absorbing a portion of the light reflected and/or scattered on the measurement scale.

### CROSS REFERENCE TO RELATED APPLICATIONS

Applicant claims priority under 35 U.S.C. §119 of European Application No. 25173655.9 filed Apr. 30, 2025, the disclosure of which is incorporated by reference.

### BACKGROUND OF THE INVENTION

### 1. Field of the Invention

The invention pertains to a linear guiding device with an optical linear measuring system.

### 2. Description of the Related Art

Linear guiding devices as such are generally known in the prior art and typically comprise a first linear guide body and a second linear guide body, wherein the second linear guide body is linearly movable relative to the first linear guide body in a first direction.

Linear guiding devices of this type can be implemented in various ways. In a typical implementation, for example, the first linear guide body may be designed in the form of a guide rail extending linearly in the first direction and the second linear guide body may be designed in the form of a guide carriage guided on the guide rail. Analogously, the second linear guide body may alternatively be designed in the form of a guide rail extending linearly in the first direction and the first linear guide body may be designed in the form of a guide carriage guided on the guide rail. In order to allow a linear movement relative to one another, the guide carriage may be supported on the guide rail of by means of rolling elements (such as balls or rollers).

Linear guiding devices of the aforementioned type are frequently used as essential components of positioning devices, which are designed for moving objects in a controlled manner and, in particular, for transporting said objects to predetermined positions. In order to allow controlled positioning, linear guiding devices of the aforementioned type therefore are usually equipped with a measuring system that is suitable for detecting a position of the second linear guide body in relation to the first linear guide body.

Measuring systems that are based on optical measuring methods for detecting a position are frequently used for high-precision position measurements. Linear guiding devices of the aforementioned type therefore are frequently equipped with an optical linear measuring system for detecting a position of the second linear guide body in relation to the first linear guide body.

An optical linear measuring system typically comprises: a measurement scale that is arranged stationarily in relation to the first linear guide body and has a plurality of markings arranged behind one another in a row; and a scanning device for optically scanning the markings of the measurement scale, wherein said scanning device is arranged stationarily in relation to the second linear guide body. A corresponding scanning device typically comprises: a light source for generating light in order to illuminate at least one area of the measurement scale comprising at least one of the markings, wherein the measurement scale is designed for reflecting and/or scattering incident light generated by the light source; and a light sensor for detecting light reflected and/or scattered on the at least one area of the measurement scale.

With respect to the implementation of an optical linear measuring system in a linear guiding device of the aforementioned type, it is frequently required to observe boundary conditions that can be restrictive, in particular, with respect to the arrangement of the light source and the light sensor of the scanning device relative to the measurement scale. For reasons of space, for example, it may not be possible to arrange the light source and/or the light sensor of the scanning device at an arbitrarily short distance from the measurement scale. For metrological reasons, it may on the other hand be necessary that the light source and/or the light sensor of the scanning device and/or the measurement scale should have specified minimum distances relative to one another in order to achieve the best measurement results possible.

In order to keep the light sensor of the scanning device at a predetermined distance from the measurement scale, a support body typically is provided for carrying the light sensor, wherein this support body is arranged stationarily in relation to the second linear guide body and the light sensor is to be fastened on said support body. Such a support body frequently is designed in such a way that the support body has a passage channel that is delimited by a lateral surface extending along a longitudinal axis of the passage channel, wherein said passage channel extends between the light sensor and the measurement scale in such a way that light reflected and/or scattered on the at least one area of the measurement scale can reach the light sensor through the passage channel and be detected by means of the light sensor. In this case, the light sensor of the scanning device is spatially separated from the measurement scale at least by individual regions of the support body and optical scanning of the markings of the measurement scale by means of the scanning device is based on the light sensor detecting light that is reflected and/or scattered on the at least one area of the measurement scale and has to pass through the passage channel of the support body.

The light that is generated by the light source and incident on the markings of the measurement scale usually can be reflected and/or scattered on the markings of the measurement scale in different directions. In addition, the spatial distribution of the light reflected and/or scattered on the markings of the measurement scale can change in relation to the passage channel of the support body when the first linear guide body is moved relative to the second guide body. Under these circumstances, it is possible that portions of the light reflected and/or scattered on the markings of the measurement scale can reach the light sensor on a direct path through the passage channel whereas other portions of the light reflected and/or scattered on the markings of the measurement scale reach the light sensor on an indirect path through the passage channel, i.e. only after further scattering and/or reflection on a surface located distant from the measurement scale, e.g. on regions of the support body. As a result, the light detected by the light sensor represents a spatial superposition of the portions of the light reflected and/or scattered on the markings of the measurement scale, which reach the light sensor on a direct path through the passage channel, and the portions of the light reflected and/or scattered on the markings of the measurement scale, which reach the light sensor on an indirect path through the passage channel.

A spatial superposition of the portions of the light reflected and/or scattered on the markings of the measurement scale, which respectively reach the light sensor directly or indirectly through the passage channel, can make it difficult to evaluate the signals generated by the light sensor and impair the measurement accuracy, with which the scanning device can determine the current position of the scanning device in relation to the individual markings of the measurement scale by evaluating the signals of the light sensor.

In this context, restrictions regarding the materials suitable for manufacturing the support body must be taken into account. For example, publication WO 2007/003065 A1 discloses a linear guiding device with an optical linear measuring system, in which the light sensor of the scanning device is integrated into a guide carriage of the linear guiding device such that the guide carriage itself or a region of the guide carriage forms a "support body" for the light sensor, which is equipped with a passage channel. Due to the requirements regarding the mechanical stability of the guide carriage, the "support body" for the light sensor is in this case preferably manufactured of a high-strength material such as steel. In this context, it has to be taken into account that surfaces of a support body made of steel can have a relatively high reflectivity for light. The option of making it impossible for light reflected or scattered on the support body to reach the light sensor by enlarging the passage channel is subject to limitations in this case because an enlargement of the passage channel can unacceptably impair the mechanical stability of the support body.

### SUMMARY OF THE INVENTION

The present invention is based on the objective of avoiding the aforementioned disadvantages and making available a linear guiding device with an optical linear measuring system, wherein said optical linear measuring system comprises a scanning device with a support body for a light sensor, which support body has a passage channel, and allows an implementation of the light sensor on the support body that can be easily and cost-effectively realized and ensures a higher measuring accuracy of the scanning device.

This objective is attained by means of a linear guiding device with the characteristics of the invention.

This linear guiding device comprises a first linear guide body and a second linear guide body, wherein the second linear guide body is linearly movable relative to the first linear guide body in a first direction; and an optical linear measuring system for detecting a position of the second linear guide body in relation to the first linear guide body.

In this case, the optical linear measuring system comprises: a measurement scale that is arranged stationarily in relation to the first linear guide body and has a plurality of markings arranged behind one another in a row; and a scanning device for optically scanning the markings of the measurement scale, which scanning device is arranged stationarily in relation to the second linear guide body.

The scanning device comprises: a light source for generating light in order to illuminate at least one area of the measurement scale comprising at least one of the markings, wherein the measurement scale is designed for reflecting and/or scattering incident light generated by the light source; a light sensor for detecting light reflected and/or scattered on the at least one area of the measurement scale; and a support body for the light sensor, wherein this support body is arranged stationarily in relation to the second linear guide body and has a passage channel that is delimited by a lateral surface extending along a longitudinal axis of the passage channel, and wherein said passage channel extends between the light sensor and the measurement scale in such a way that light reflected and/or scattered on the at least one area of the measurement scale is enabled to reach the light sensor through the passage channel and be detected by means of the light sensor.

According to the invention, an antireflective body is arranged on the support body, wherein the antireflective body has a first section, which consists of a material that is suitable for absorbing light generated by means of the light source and furthermore ensures that the first section has a lower reflectivity for the light reflected and/or scattered on the at least one area of the measurement scale than the sidewall of the passage channel. The first section of the antireflective body extends through a first segment of the passage channel of the support body along the lateral surface of the passage channel of the support body in such a way that a second segment of the passage channel of the support body is present adjacent to the first section of the antireflective body such that at least a portion of the light reflected and/or scattered on the at least one area is enabled to directly pass through the second segment of the passage channel of the support body and reach the light sensor without being reflected on the sidewall of the passage channel of the support body and without being affected by the antireflective body in order to be detectable by means of the light sensor, wherein another portion of the light reflected and/or scattered on the at least one area of the measurement scale, which is reflected and/or scattered in the direction of the sidewall of the passage channel of the support body, is enabled to be absorbed by the antireflective body and therefore is prevented from being reflected on the sidewall of the passage channel of the support body and/or from reaching the light sensor and being detectable by means of the light sensor after a reflection on the sidewall of the passage channel of the support body.

The antireflective body is suitable for cooperating with the optical linear measuring system in such a way that the accuracy, with which a position of the scanning device in relation to the markings of the measurement scale can be determined based on an evaluation of signals of the light sensor, is increased (in comparison with an implementation of the support body without an arrangement of the antireflective body) due to the arrangement of the first section of the antireflective body in the passage channel of the support body.

This is achieved, in particular, in that the first section of the antireflective body merely extends through a first segment of the passage channel of the support body in such a way that at least a portion of the light reflected and/or scattered on the at least one area of the measurement scale is enabled to reach the light sensor on a "direct" path (through a "second segment of the passage channel" of the support body that differs from the "first segment" of the passage channel), i.e. without a reflection on the sidewall of the passage channel of the support body and without being affected by the antireflective body, and therefore can contribute to a signal of the light sensor providing information with respect to a position of the scanning device in relation to the markings of the measurement scale.

Due to the fact that the first section of the antireflective body consists of a material that is suitable for absorbing light generated by means of the light source and furthermore ensures that the first section has a lower reflectivity for the light reflected and/or scattered on the at least one area of the measurement scale than the sidewall of the passage channel, it is ensured that another portion of the light reflected and/or scattered on the at least one area of the measurement scale, which is reflected and/or scattered in the direction of the sidewall of the passage channel of the support body, is absorbed in the first section of the antireflective body and therefore cannot be detected by means of the light sensor. In this way, at least a portion of the light reflected and/or scattered on the at least one area of the measurement scale is prevented from reaching the light sensor on an "indirect" path (i.e. after a reflection on the sidewall of the passage channel of the support body or on a surface of the antireflective body) due to a suitable arrangement of the first section of the antireflective body in the passage channel. A suitable implementation of the antireflective body therefore makes it possible to ensure that the light sensor exclusively detects light that reaches the light sensor without having been reflected or scattered on the support body. The presence of the antireflective body consequently results in an enhanced measuring accuracy of the scanning device.

The antireflective body is a separate body that can consist of a different material than the support body or the first linear guide body or the second linear guide body and therefore can be cost-effectively manufactured independently of the support body or the first linear guide body or the second linear guide body. Furthermore, the antireflective body can be easily and quickly arranged on the support body and therefore allows an implementation on the support body, which can be quickly and cost-effectively realized in the course of automated production processes. An implementation of the antireflective body particularly does not require any special processing of the support body. This allows a cost-effective implementation of the antireflective body in combination with an implementation of the optical linear measuring system.

An embodiment of the linear guiding device can be realized, for example, in such a way that the first linear guide body is designed in the form of a guide rail extending linearly in the first direction and the second linear guide body is designed in the form of a guide carriage guided on the guide rail. Alternatively, the second linear guide body may be designed in the form of a guide rail extending linearly in the first direction and the first linear guide body may be designed in the form of a guide carriage guided on the guide rail.

An embodiment of the linear guiding device may be designed in such a way that the support body is an integral component of the second linear guide body. Accordingly, the "support body" may, for example, be a section of a guide carriage of the linear guiding device, e.g. a guide carriage made of steel, wherein it is proposed to fasten the light sensor of the scanning device on the guide carriage itself.

An embodiment of the linear guiding device is designed in such a way that the antireflective body has a passage channel in the first section of the antireflective body, wherein said passage channel extends through the second segment of the passage channel of the support body along the longitudinal axis of the passage channel of the support body. In this case, the antireflective body may be designed in such a way that a portion of the light reflected and/or scattered on the at least one area of the measurement scale is enabled to pass through the passage channel formed in the first section of the antireflective body and reach the light sensor on a "direct" path (without reflection on the sidewall of the passage channel and without being affected by the antireflective body itself). In this case, the first section of the antireflective body is shaped in such a way that the passage channel formed in the first section of the antireflective body is laterally delimited by a wall section extending annularly around the longitudinal axis of the passage channel. This annularly extending wall section extends in the passage channel of the support body along the sidewall of the passage channel of the support body and therefore is suitable for preventing a potential reflection of light reflected and/or scattered on the at least one area of the measurement scale on the sidewall of the passage channel of the support body in the direction of the light sensor along the entire circumference of the wall section.

An embodiment of the linear guiding device is designed in such a way that the support body has a first surface and a second surface lying opposite of the first surface, wherein the second surface has a shorter distance in relation to the measurement scale than the first surface, wherein a first supporting surface extending radially to the longitudinal axis of the passage channel of the support body is formed on the first surface, and wherein the first supporting surface serves for supporting the scanning device or the antireflective body. The formation of the first supporting surface on the first surface of the support body allows a simple installation of the scanning device and/or the antireflective body on the support body because the first surface of the support body is arranged in a region of the support body located distant from the measurement scale and therefore can be easily accessible for an installation of the scanning device and/or the antireflective body.

An enhancement of the aforementioned embodiment of the linear guiding device is designed in such a way that the support body has a first recess on the first surface, wherein the first recess extends longitudinally to the longitudinal axis of the passage channel of the support body, and wherein the first supporting surface is formed in the first recess such that the first recess is delimited by the first supporting surface. The formation of the first supporting surface in the first recess allows a simple installation of the scanning device and/or the antireflective body. In order to simplify the installation, the shape of the recess particularly may be adapted to the shape of the scanning device to be installed and/or the shape of the antireflective body to be installed.

In addition, it would (optionally) be possible that the support body has a second recess on the first surface, wherein this second recess is formed adjacent to the first supporting surface in such a way that the second recess extends longitudinally to the longitudinal axis of the passage channel of the support body and is delimited by a second supporting surface in a region of the second recess, and wherein this second supporting surface extends radially to the longitudinal axis of the passage channel of the support body. The first supporting surface and the second supporting surface represent two separate supporting surfaces, on which the scanning device and the antireflective body can be implemented separately of one another.

In addition, it would (optionally) be possible that the antireflective body has at least one second section that is designed in the form of a shoulder extending radially to the longitudinal axis of the passage channel of the support body, wherein the antireflective body is or is configured to be placed on the support body in such a way that the first section of the antireflective body is arranged in the first segment of the passage channel of the support body and the at least one second section of the antireflective body is brought in contact with the second supporting surface of the support body.

A simple installation of the antireflective body is achieved due to the design of the second section of the antireflective body in the form of a shoulder extending radially to the longitudinal axis of the passage channel of the support body in conjunction with the design of the second supporting surface of the support body. In order to install the antireflective body, it is merely required to insert the first section of the antireflective body into the passage channel of the support body and to bring the second section of the antireflective body (i.e. the shoulder) in contact with the second supporting surface of the support body. In this way, the second supporting surface of the support body forms a stable seat for the antireflective body on the support body.

With respect to the arrangement of the scanning device, the linear guiding device may be designed in such a way that the scanning device is or is configured to be placed on the support body in such a way that the scanning device is brought in contact with the first supporting surface of the support body.

An embodiment of the linear guiding device is designed in such a way that the antireflective body is fastened on the scanning device, wherein the scanning device is or is configured to be placed on the support body in such a way that the scanning device is brought in contact with the first supporting surface of the support body and the first section of the antireflective body is arranged in the first segment of the passage channel of the support body. When the antireflective body is fastened on the scanning device, the scanning device and the antireflective body form a unit that can be implemented as a whole on the support body by bringing the scanning device in contact with the first supporting surface of the support body. In this case, the first supporting surface of the support body forms a stable seat for the scanning device and the antireflective body on the support body.

An embodiment of the linear guiding device is designed in such a way that the antireflective body has at least one second section that is designed in the form of a shoulder extending radially to the longitudinal axis of the passage channel of the support body, wherein the antireflective body is or is configured to be placed on the support body in such a way that the second section of the antireflective body is brought in contact with the first supporting surface of the support body and the first section of the antireflective body is arranged in the first segment of the passage channel of the support body. In addition, a third supporting surface for the scanning device extending radially to the longitudinal axis of the passage channel of the support body may be formed on the second section of the antireflective body in a region of the second section of the antireflective body located distant from the first supporting surface of the support body, wherein the scanning device is or is configured to be placed on the antireflective body in such a way that the scanning device is in contact with the third supporting surface and is or is configured to be held in a predetermined position in relation to the antireflective body by means of the third supporting surface.

When the scanning device is placed on the third supporting surface formed on the second section of the antireflective body, the antireflective body and the scanning device form a unit that can be implemented as a whole on the supporting body by bringing the antireflective body in contact with the first supporting surface of the support body. In this case, the first supporting surface of the support body forms a stable seat for the antireflective body and the scanning device on the support body.

The above-described embodiments of the linear guiding device may be designed in such a way that the antireflective body is made of a plastic material. The antireflective body therefore can be cost-effectively produced with conventional manufacturing methods (e.g. injection molding) of a known plastic material, which at least ensures that the antireflective body can be implemented on the support body and has a sufficient mechanical stability for this implementation.

A colorant may be dispersed in the plastic material used for manufacturing the antireflective body, wherein said colorant is suitable for absorbing light that is enabled to be generated by means of the light source. The colorant dispersed in the plastic material intensifies the absorption of the light that is enabled to be generated by means of the light source in the antireflective body. A suitable choice of the plastic material and, if applicable, a suitable choice of a colorant dispersed in the plastic material preferably makes it possible to ensure that the light reflected and/or scattered on the measurement scale cannot pass through the antireflective body, wherein the light incident on the antireflective body is completely absorbed in the antireflective body. The light incident on the antireflective body consequently can no longer advance to a surface of the support body and accordingly also not be reflected on the surface of the support body.

The antireflective body may (optionally) be designed in such a way that the antireflective body has a surface that has a roughness with a mean roughness index Ra in the range 0.8 µm < Ra < 4.5 µm at least in a region that is accessible for the light reflected and/or scattered on the at least one area of the measurement scale. Such a roughness of the surface of the antireflective body is suitable for reducing the reflectivity of the surface of the antireflective body for the light reflected and/or scattered on the at least one area of the measurement scale.

The aforementioned measures contribute to significantly reducing or minimizing or eliminating the portion of the light reflected and/or scattered on the at least one area of the measurement scale, which could reach the light sensor on an "indirect" path (after being reflected and/or scattered on a surface of the antireflective body).

An embodiment of the linear guiding device is designed in such a way that the shape of the first section of the antireflective body is adapted to the shape of the passage channel of the support body such that the first section of the antireflective body is configured to be inserted into the passage channel of the support body and clamped between different regions of the lateral surface of the passage channel of the support body in order to hold the antireflective body in a predetermined position in relation to the support body. This design allows a particularly simple and efficient implementation of the antireflective body on the support body.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

### In the Drawings

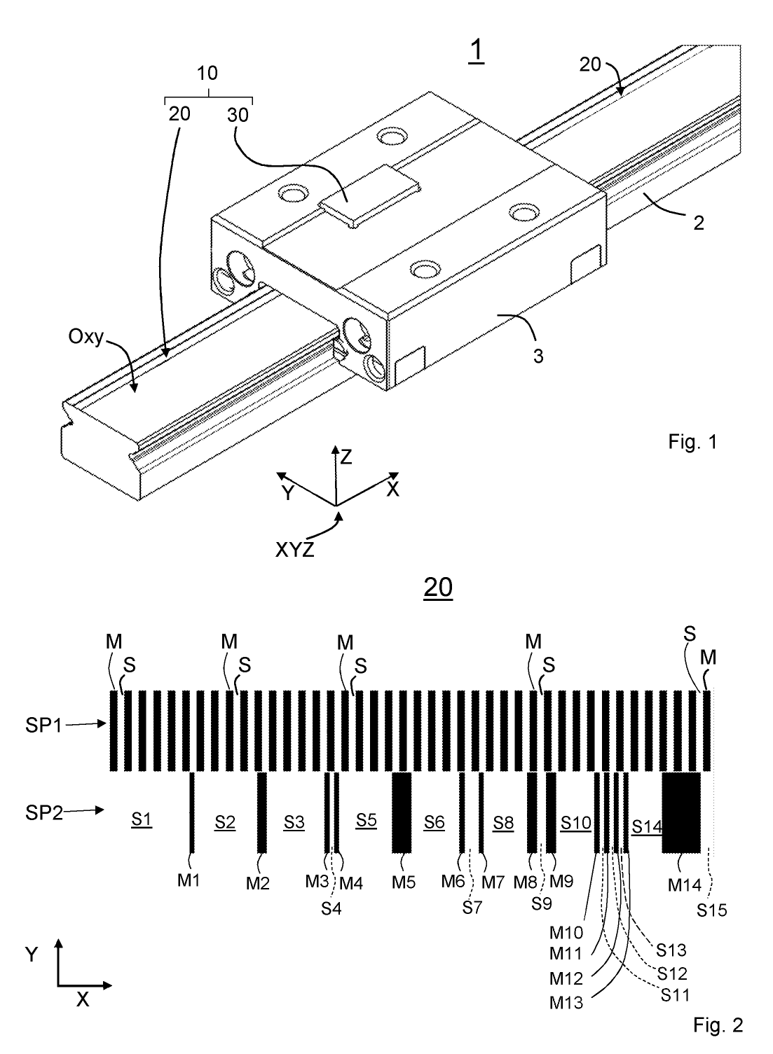

FIG. 1 shows a perspective view of an inventive linear guiding device with a first linear guide body, a second linear guide body and an optical linear measuring system, wherein the first linear guide body is designed in the form of a guide rail extending linearly in a first direction (X) and the second linear guide body is designed in the form of a guide carriage guided on the guide rail, and wherein the optical linear measuring system comprises a measurement scale arranged on the guide rail and a scanning device arranged on the guide carriage;

FIG. 2 shows an arrangement of markings in a section of the measurement scale of the linear guiding device according to FIG. 1, namely in the form of an enlarged top view of a surface of the guide rail according to FIG. 1;

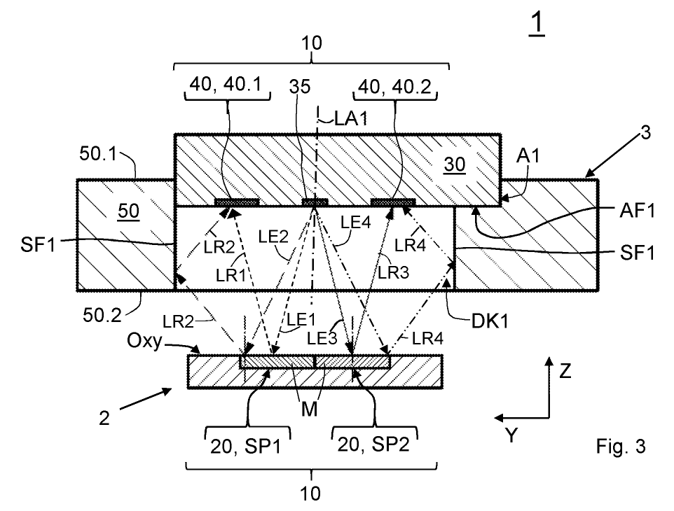

FIG. 3 shows the linear guiding device according to FIG. 1 in the form of a cross section perpendicular to the first direction (X), namely without an inventive antireflective body;

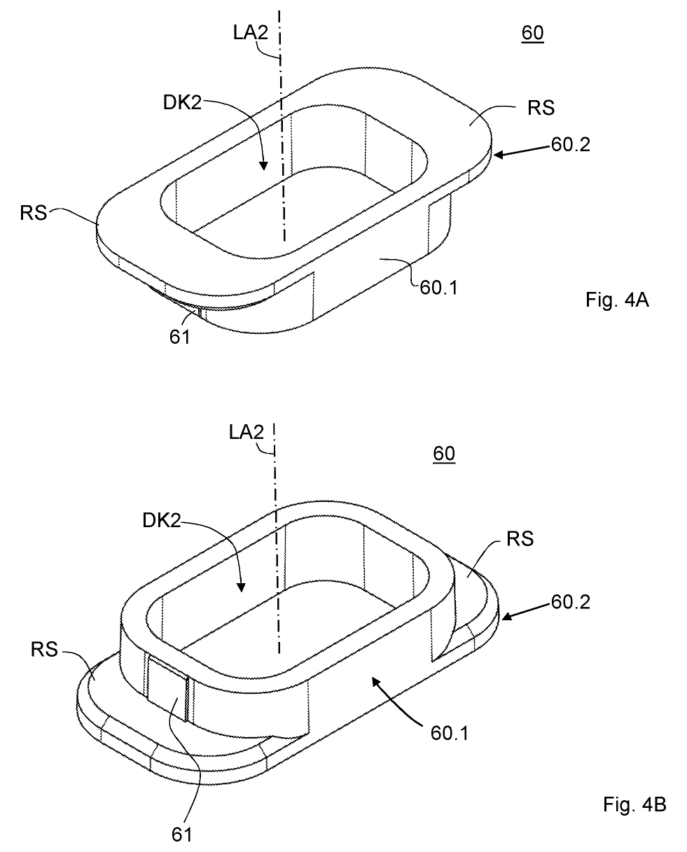

FIG. 4A shows a first embodiment of an antireflective body according to the invention in the form of a perspective view;

FIG. 4B shows the antireflective body according to FIG. 4A in the form of a view from a different perspective;

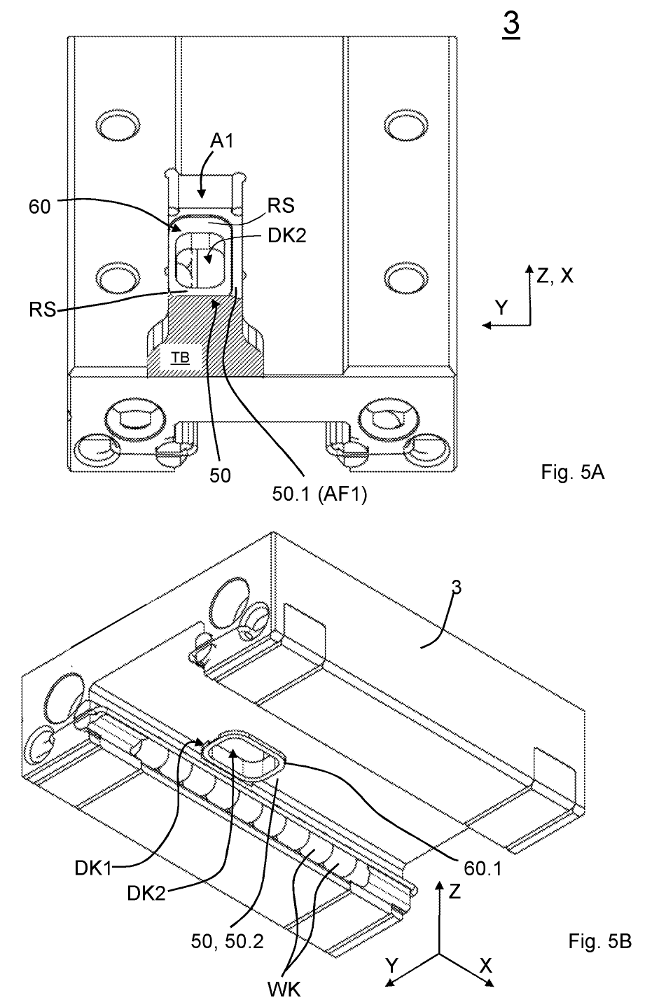

FIG. 5A shows a perspective view of the guide carriage of the linear guiding device according to FIG. 1 with an antireflective body according to FIGS. 4A or 4B, but without the scanning device of the optical linear measuring system such that the antireflective body is visible;

FIG. 5B shows a perspective view of the guide carriage of the linear guiding device according to FIG. 1 as illustrated in FIG. 5A, but viewed from a different perspective;

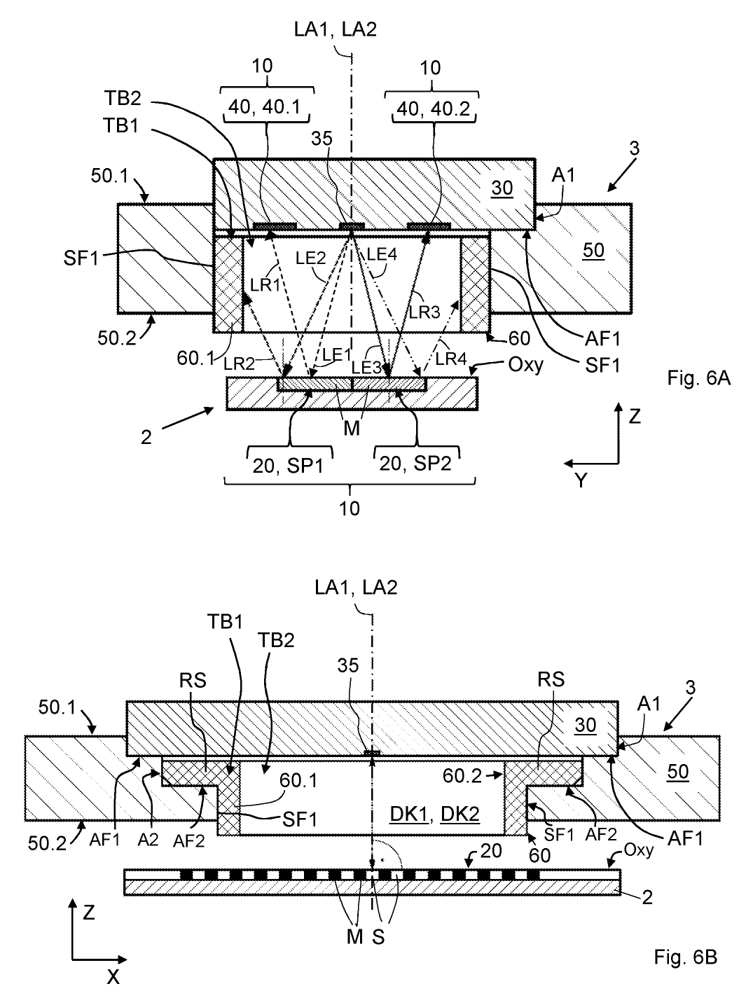

FIG. 6A shows the linear guiding device according to FIG. 1 with an antireflective body according to FIGS. 4A or 4B in the form of a cross section through the guide carriage and the guide rail perpendicular to the longitudinal axis of the guide rail;

FIG. 6B shows the linear guiding device according to FIG. 1 with an antireflective body according to FIGS. 4A or 4B in the form of a longitudinal section through the guide carriage and the guide rail along the longitudinal axis of the guide rail;

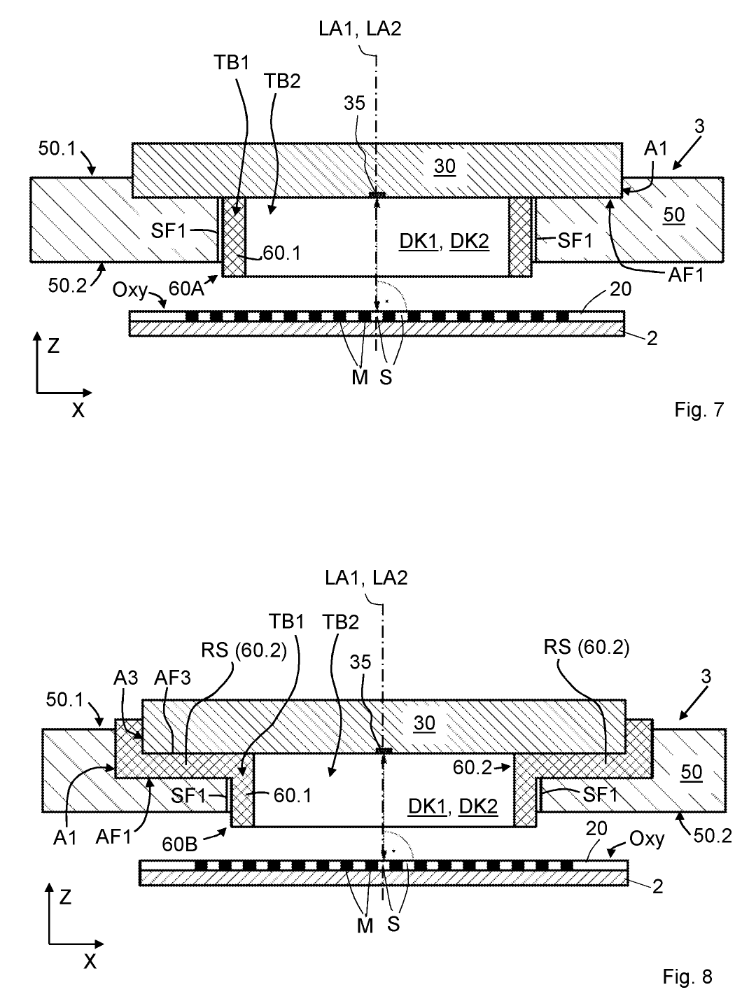

FIG. 7 shows the linear guiding device according to FIG. 1 with a second embodiment of an antireflective body in the form of a longitudinal section through the guide carriage and the guide rail along the longitudinal axis of the guide rail; and

FIG. 8 shows the linear guiding device according to FIG. 1 with a third embodiment of an antireflective body in the form of a longitudinal section through the guide carriage and the guide rail along the longitudinal axis of the guide rail.

### DETAILED DESCRIPTION OF PREFERRED EMBODIMENTS

Unless stated otherwise, identical elements are respectively identified by the same reference symbols in the figures.

FIG. 1 shows a perspective view of an inventive linear guiding device 1 that comprises a first linear guide body 2 and a second linear guide body 3, wherein the second linear guide body 3 is linearly movable relative to the first linear guide body 2 in one direction. In the present example, it is assumed that the linear guiding device 1 is designed in the form of a linear profiled rail guide that has a guide rail extending linearly in a first direction and a guide carriage guided on the guide rail. In this case, it is particularly assumed that the first linear guide body 2 of the linear guiding device 1 forms the linear guide rail of the linear profiled rail guide and therefore has a longitudinal axis that extends linearly in the first direction. It is accordingly assumed that the second linear guide body 3 of the linear guiding device 1 forms the guide carriage of the linear profiled rail guide, wherein said guide carriage is respectively supported and guided on the guide rail illustrated in FIG. 1 in such a way that the second linear guide body 3 is linearly movable in the first direction. For this purpose, the second linear guide body 3 (guide carriage) may be supported on the first linear guide body 2 (guide rail), for example, by means of rolling elements WK that are not visible in FIG. 1, but illustrated in FIG. 5B.

In the illustration according to FIG. 1, it is assumed that the X-axis of a Cartesian coordinate system XYZ, which is illustrated in FIG. 1 and has three orthogonal axes X, Y and Z (X-axis, Y-axis and Z-axis), extends in the aforementioned "first" direction (that corresponds to the longitudinal axis of the guide rail), and that the second linear guide body 3 therefore is linearly movable in the direction of the X-axis. Accordingly, the aforementioned "first direction" is also referred to as "X-direction" below.

As indicated in FIG. 1, the linear guiding device 1 has an optical linear measuring system 10 for detecting a position of the second linear guide body 3 in relation to the first linear guide body 2. This optical linear measuring system 10 comprises a measurement scale 20, which is arranged stationarily in relation to the first linear guide body 2 and has a plurality of markings that are arranged behind one another in a row (and not illustrated in FIG. 1), as well as a scanning device 30 for optically scanning the markings of the measurement scale 20, wherein said scanning device 30 is arranged stationarily in relation to the second linear guide body 3.

In the present example, the measurement scale 20 is arranged on a plane surface region Oxy of the first linear guide body 2, wherein this plane surface region extends parallel to the X-axis and parallel to the Y-axis of the Cartesian coordinate system XYZ illustrated in FIG. 1. The measurement scale comprises a plurality of markings that are arranged behind one another in one or more rows extending in the X-direction.

The scanning device 30 accordingly is fastened on the second linear guide body 3 such that the scanning device 30 is also moved in the X-direction during a movement of the second linear guide body 3 in the X-direction and the individual markings of the measurement scale 20 can be successively detected by means of the scanning device 30 during a movement of the second linear guide body 3 in the X-direction.

Further details of the optical linear measuring system 10 and, in particular, the measurement scale 20 and the scanning device 30 are explained below with reference to FIGS. 2 and 3.

In the present example, it is assumed that the individual markings of the measurement scale 20 in the surface region Oxy of the first linear guide body 2 were realized by machining the surface region Oxy in different areas that correspond to the respective markings (and are referred to as "marking areas" below). It is particularly assumed that the surface region Oxy has - prior to a machining operation for the purpose of realizing the markings - a predetermined reflectivity for light, and that machining of the surface of the first linear guide body 2 in the individual marking areas has the effect of reducing the reflectivity in the machined areas of the surface region Oxy (i.e. in the individual marking areas) in comparison with the reflectivity in the non-machined areas of the surface region Oxy. Accordingly, the markings of the measurement scale 20 differ from the non-machined areas of the measurement scale in that light incident on the measurement scale is in the individual marking areas reflected and/or scattered with a lower intensity than in the non-machined areas of the surface region Oxy.

Methods for realizing the aforementioned markings of the measurement scale 20 are generally known. For example, the surface of the first linear guide body 2 may be machined in the respective marking areas with a pulsed laser beam (e.g. as described in publication EP 4350303 A1).

Since the non-machined areas of the surface region Oxy have a higher reflectivity for light than the individual marking areas, the non-machined areas of the surface region Oxy are referred to as "mirror areas" below.

In the present example, the measurement scale 20 comprises at least one track that extends in the X-direction and has multiple mirror areas and marking areas, which are alternately arranged behind one another.

As indicated in FIG. 2, the measurement scale 20 comprises, for example, two different tracks that are arranged in the surface region Oxy of the first linear guide body 2 and extend parallel to one another in the X-direction, wherein said tracks have multiple mirror areas and marking areas, which are alternately arranged behind one another: a first track SP1, which is designed in the form of an incremental track with a plurality of equidistantly arranged marking areas, and a second track SP2, which is designed in the form of a reference track and has at least one marking area for coding at least one reference position or may alternatively also have multiple marking areas that are arranged behind one another in the X-direction and serve for coding several different reference positions.

As indicated in FIG. 2, each of the marking areas of the first track SP1 and the second track SP2 of the measurement scale 20 respectively extends in the surface region Oxy of the first linear guide body 2 linearly in the direction of the Y-axis illustrated in FIGS. 1 and 2, i.e. transverse to the longitudinal direction of the measurement scale 20.

As indicated in FIG. 2, the first track SP1 (incremental track) comprises a plurality of marking areas M that are identical with respect to their geometric shape and their spatial extent in the direction of the X-axis, as well as with respect to their spatial extent in the direction of the Y-axis. A mirror area S is respectively formed between two adjacent marking areas M that are arranged directly behind one another in the direction of the X-axis, wherein all mirror areas S of the first track SP1 are identical with respect to their spatial extent in the direction of the X-axis and with respect to their spatial extent in the direction of the Y-axis.

As furthermore indicated in FIG. 2, the second track SP2 (reference track) comprises in the present example multiple (in this example a total of fourteen) marking areas M1, M2, M3, M4, M5, M6, M7, M8, M9, M10, M11, M12, M13 and M14 that are arranged behind one another in a row in the X-direction.

With respect to the second track SP2, a mirror area is also respectively formed between two adjacent marking areas that are arranged directly behind one another in the direction of the X-axis such that the aforementioned marking areas M1, M2, M3, M4, M5, M6, M7, M8, M9, M10, M11, M12, M13 and M14 are arranged behind one another in a row alternately with mirror areas S1, S2, S3, S4, S5, S6, S7, S8, S9, S10, S11, S12, S13, S14 and S15. However, not all marking areas M1, M2, M3, M4, M5, M6, M7, M8, M9, M10, M11, M12, M13 and M14 of the second track SP2 are identical to one another with respect to their spatial extent in the direction of the X-axis. Likewise, not all mirror areas S1, S2, S3, S4, S5, S6, S7, S8, S9, S10, S11, S12, S13, S14 and S15 are identical to one another with respect to their spatial extent in the direction of the X-axis. In this way, the different marking areas and mirror areas of the second track SP2 allow coding of several different reference positions, which respectively clearly define several different absolute positions.

In FIG. 3, the scanning device 30 is arranged in relation to the measurement scale 20 in such a way that the markings of the measurement scale 20 can be scanned by means of the scanning device 30 in order to determine a position of the second linear guide body 3 in relation to the first linear guide body 2.

FIG. 3 shows the linear guiding device 1 according to FIG. 1 in the form of a cross section perpendicular to the X-axis, but an inventive antireflective body is not implemented and therefore not visible in this figure.

FIG. 3 in combination with FIG. 1 indicates that the scanning device 30 is fastened on the second linear guide body 3 and supported on a region of the second linear guide body 3 in such a way that the scanning device 30 is arranged at a predetermined distance from the measurement scale 20 when the second linear guide body 3 carries out a linear movement relative to the first linear guide body 2 in the X-direction.

FIG. 3 particularly shows the scanning device 30 together with a region of the second linear guide body 3, on which the scanning device 30 is supported (in the form of a cross section perpendicular to the X-axis). A region of the second linear guide body , on which the scanning device 30 is supported, has the function of carrying the scanning device 30 and, in the context of the present invention, is accordingly referred to as "support body" and identified by the reference symbol "50" below.

As indicated in FIGS. 1 and 3, the support body 50 is in the present example designed in the form of an integral component of the second linear guide body 3. It should be noted that the support body 50 may alternatively also be designed in the form of a separate component that is arranged stationarily in relation to the second linear guide body 3, but may be arranged spatially separate of the second linear guide body 3.

As indicated in FIG. 3, the support body 50 has a first surface 50.1 and a second surface 50.2 lying opposite of the first surface 50.1, wherein the first surface 50.1 and the second surface 50.2 extend in the present example essentially parallel to the surface region Oxy of the first linear guide body 2, on which the measurement scale 20 is arranged. In the present example, the second surface 50.2 has a shorter distance in relation to the measurement scale 20 than the first surface 50.1.

The scanning device 30 is arranged on the first surface 50.1 of the support body 50 as indicated in FIG. 3. This arrangement of the scanning device has the advantage that the scanning device 30 is accessible from a surface of the support body 50 located distant from the measurement scale 20, namely even if the support body 50 is mounted at a predetermined distance from the measurement scale 20. For example, this arrangement of the scanning device 30 can simplify an installation of the scanning device 30 on the support body 50 or a removal of the scanning device 30 from the support body 50.

In order to allow optical scanning of the markings of the measurement scale 20, the support body 50 has a passage channel DK1, which extends continuously between the first surface 50.1 and the second surface 50.2 of the support body 50 along a longitudinal axis LA1 of the passage channel DK1 such that the passage channel DK1 is delimited by a lateral surface SF1 extending along the longitudinal axis LA1 of the passage channel DK1.

As indicated in FIG. 3, the passage channel DK1 extends through the support body 50 in such a way that the longitudinal axis LA1 of the passage channel DK1 essentially extends perpendicular to the surface region Oxy of the first linear guide body 2, on which the measurement scale 20 is arranged.

FIG. 3 shows that the scanning device 30 and the measurement scale 20 are arranged in relation to the passage channel DK1 of the support body 50 in such a way that the scanning device 30 and the measurement scale 20 are positioned on opposite sides of the support body 50, wherein the passage channel DK1 extends between the scanning device 30 and the measurement scale 20 in such a way that the scanning device 30 and the measurement scale 20 lie on the longitudinal axis LA1 of the passage channel DK1.

In order to allow a simple installation of the scanning device 30 in a stable position on the support body 50, a first supporting surface AF1 extending radially to the longitudinal axis LA1 of the passage channel DK1 of the support body 50 is formed on the first surface 50.1 of the support body 50, wherein this first supporting surface AF1 serves in the present example for respectively supporting or carrying the scanning device 30. Accordingly, the scanning device is in the present example fastened on the support body 50 in such a way that the scanning device 30 is brought in contact with the supporting surface AF1 and therefore is seated on the surface 50.1 or, in particular, on the supporting surface AF1.

As indicated in FIG. 3, the support body may (optionally) be designed in such a way that the support body 50 has a first recess A1 on the first surface 50.1, wherein this first recess extends longitudinally to the longitudinal axis LA1 of the passage channel DK1 of the support body 50, and wherein the first supporting surface AF1 of the support body 50 is formed in the first recess A1 such that the first recess A1 is delimited by the first supporting surface AF1. In the present example, the scanning device is arranged on the first supporting surface AF1 in such a way that at least part of the scanning device 30 extends through the first recess A1 along the longitudinal axis LA1 of the passage channel DK1.

Details of the scanning device 30, which concern the function of the scanning device 30 with respect to its optical scanning of the markings of the measurement scale 20, are described below with reference to FIG. 3. It should be noted that FIG. 3 shows the scanning device 30 in the form of a schematic representation that should characterize relevant functional elements of the scanning device 30 with respect to their function, but, if applicable, discloses the physical structure of a concrete realization of the respective functional elements in a simplified manner.

FIG. 3 shows that the scanning device 30 has a light source 35 (such as an LED) on its side facing the measurement scale 20, wherein said light source is intended for generating light in order to illuminate at least one area of the measurement scale 20. For this purpose, the light source 35 is designed for generating light that propagates through the passage channel DK1 of the support body 50 such that a portion of the light generated by the light source 35 is incident on the first track SP1 of the measurement scale 20 and another portion of the light emitted by the light source 35 is incident on the second track SP2 of the measurement scale 20.

As indicated in FIG. 3, the light source 35 is designed such that the light emitted by the light source 35 propagates along the longitudinal axis LA1 of the passage channel DK1 in such a way that the light propagating to the measurement scale 20 diverges in relation to the longitudinal axis LA1 of the passage channel DK1. In order to visualize these circumstances, the light that is emitted by the light source 35 and incident on the measurement scale is in FIG. 3 represented by a pencil of four light rays, which are identified by the reference symbols "LE1", "LE2", "LE3" and "LE4" and differ in that the light rays LE1, LE2, LE3 and LE4 are, starting from the light source 35, inclined in relation to the longitudinal axis LA1 of the passage channel DK1 with different angles and accordingly incident on the surface region Oxy of the first linear guide body 2, on which the measurement scale 20 is arranged, with different angles in relation to the longitudinal axis LA1 of the passage channel DK1. In the illustration according to FIG. 3, it is assumed that the light rays LE1 and LE2 are incident on the marking areas and/or mirror areas of the first track SP1 of the measurement scale 20 whereas the light rays LE3 and LE4 are incident on the marking areas and/or mirror areas of the second track SP2 of the measurement scale 20.

The light that is generated by the light source 35 and incident on the measurement scale 20 is reflected and/or scattered on the mirror areas and marking areas of the measurement scale 20 in different ways. Since the light incident on the measurement scale 20 arrives on the surface region Oxy of the first linear guide body 2 with different angles in relation to the longitudinal axis LA1 of the passage channel DK1 in different areas of the measurement scale 20, the light incident on different areas of the measurement scale 20 typically is reflected and/or scattered in different directions in relation to the longitudinal axis LA1 of the passage channel DK1.

In order to visualize these circumstances, it is assumed that the light represented by the light ray LE1 is in the illustration according to FIG. 3 reflected and/or scattered on the measurement scale 20 in such a way that the reflected or scattered light is represented by a light ray identified by the reference symbol "LR1." It is analogously assumed that the light represented by the light rays LE2, LE3 and LE4 is reflected and/or scattered on the measurement scale 20 in such a way that the reflected or scattered light is represented by light rays identified by the reference symbols "LR2", "LR3" and "LR4." As indicated in FIG. 3, the light represented by the light rays LR1, LR2, LR3 and LR4 respectively propagates - starting from the surface region Oxy of the first linear guide body 2 - with different angles relative to the longitudinal axis LA1 of the passage channel DK1.

In order to allow optical scanning of the measurement scale 20, the scanning device 30 comprises a light sensor 40 for detecting the light that is generated by the light source 35 and reflected and/or scattered on the measurement scale 20. In the present example, the light sensor 40 particularly is designed for detecting the light reflected and/or scattered on the first track SP1 of the measurement scale 20 and the light reflected and/or scattered on the second track SP2 of the measurement scale 20, as well as for analyzing the spatial distribution of the intensity of the light reflected and/or scattered on the first track SP1 of the measurement scale and the spatial distribution of the intensity of the light reflected and/or scattered on the second track SP2 of the measurement scale 20.

For this purpose, the light sensor 40 comprises a first arrangement 40.1 of a plurality of photo sensors for detecting the light reflected and/or scattered on the first track SP1 of the measurement scale 20 and a second arrangement 40.2 of a plurality of photo sensors for detecting the light reflected and/or scattered on the second track SP2 of the measurement scale 20, as well as additional (not-shown) electronic elements that are designed for evaluating corresponding output signals of the first arrangement 40.1 of photo sensors and/or output signals of the second arrangement 40.2 of photo sensors.

As mentioned above, the measurement scale 20 is designed in such a way that the individual marking areas, i.e. the marking areas M of the first track SP1 and the marking areas M1, M2, M3, M4, M5, M6, M7, M8, M9, M10, M11, M12, M13 and M14 of the second track SP2, have a lower reflectivity for light than the respective mirror areas, i.e. the mirror areas S of the first track SP1 and the mirror areas S1, S2, S3, S4, S5, S6, S7, S8, S9, S10, S11, S12, S13, S14 and S15 of the second track.

Under the aforementioned circumstances, the spatial distribution of the intensity of the light reflected and/or scattered on the first track SP1 of the measurement scale 20 has a spatial variation in the X-direction, which spatial variation corresponds to the spatial arrangement of the mirror areas S of the first track SP1 in the X-direction. Accordingly, the spatial distribution of the intensity of the light reflected and/or scattered on the second track SP2 of the measurement scale 20 has a spatial variation in the X-direction, which spatial variation corresponds to the spatial arrangement of the mirror areas S1, S2, S3, S4, S5, S6, S7, S8, S9, S10, S11, S12, S13, S14 and S15 of the second track SP2 in the X-direction.

As indicated in FIG. 3, the first arrangement 40.1 of photo sensors comprises a plurality of photo sensors that are arranged behind one another in a row in the X-direction (and not illustrated in FIG. 3). Accordingly, the second arrangement 40.2 of photo sensors comprises a plurality of photo sensors that are arranged behind one another in a row in the X-direction (and not illustrated in FIG. 3).

As indicated in FIG. 3, the light that is generated by the light source 35 and reflected and/or scattered on the measurement scale 20 can reach the first arrangement 40.1 of photo sensors and the second arrangement 40.2 of photo sensors of the light sensor 40 on different paths. The light that is emitted by the light source 35 and incident on the first track SP1 of the measurement scale 20 in accordance with the light ray LE1, for example, is reflected and/or scattered on the first track SP1 of the measurement scale in such a way that the light reflected and/or scattered in accordance with the light ray LR1 illustrated in FIG. 3 propagates through the passage channel DK1 of the support body 50 and - starting from the first track SP1 of the measurement scale - reaches the first arrangement 40.1 of photo sensors on a direct path . The light propagating in accordance with the light ray LR1 therefore is suitable for being detected by means of the first arrangement 40.1 of photo sensors.

In contrast, the light that is emitted by the light source 35 and incident on the first track SP1 of the measurement scale 20 in accordance with the light ray LE2 is reflected and/or scattered on the first track SP1 of the measurement scale 20 in such a way that the light reflected and/or scattered in accordance with the light ray LR2 illustrated in FIG. 3 propagates through the passage channel DK1 of the support body 50 and - starting from the first track SP1 of the measurement scale - initially is incident on the sidewall SF1 of the passage channel DK1 and then reflected and/or scattered on the sidewall SF1 in such a way that the light propagating in accordance with the light ray LR2 ultimately is also incident on the first arrangement 40.1 of photo sensors. The light propagating in accordance with the light ray LR2 therefore is suitable for reaching the first arrangement 40.1 of photo sensors on an indirect path (in the present example after being reflected or scattered on the support body 50) and for likewise being detected by means of the first arrangement 40.1 of photo sensors.

As likewise indicated in FIG. 3, the light that is emitted by the light source 35 and incident on the second track SP2 of the measurement scale 20 in accordance with the light ray LE3 can be reflected and/or scattered on the second track SP2 of the measurement scale in such a way that the light reflected and/or scattered in accordance with the light ray LR3 illustrated in FIG. 3 propagates through the passage channel DK1 of the support body 50 and - starting from the second track SP2 of the measurement scale - reaches the second arrangement 40.2 of photo sensors on a direct path. The light propagating in accordance with the light ray LR3 therefore is suitable for being detected by means of the second arrangement 40.2 of photo sensors.

In contrast, the light that is emitted by the light source 35 and incident on the second track SP2 of the measurement scale 20 in accordance with the light ray LE4 is reflected and/or scattered on the second track SP2 of the measurement scale in such a way that the light reflected and/or scattered in accordance with the light ray LR4 illustrated in FIG. 3 propagates through the passage channel DK1 of the support body 50 and - starting from the second track SP2 of the measurement scale - initially is incident on the sidewall SF1 of the passage channel DK1 and then reflected and/or scattered on the sidewall SF1 in such a way that the light propagating in accordance with the light ray LR4 ultimately is also incident on the second arrangement 40.2 of photo sensors. The light propagating in accordance with the light ray LR4 therefore is suitable for reaching the second arrangement 40.2 of photo sensors on an indirect path (in the present example after being reflected or scattered on the support body 50) and for likewise being detected by means of the second arrangement 40.2 of photo sensors.

As mentioned above, optical scanning of the measurement scale 20 by means of the scanning device 30 is, among other things, based on detecting the light reflected and/or scattered on the first track SP1 of the measurement scale 20 and the light reflected and/or scattered on the second track SP2 of the measurement scale 20 and analyzing the spatial distribution of the intensity of the light reflected and/or scattered on the first track SP1 of the measurement scale 20 and the spatial distribution of the intensity of the light reflected and/or scattered on the second track SP2 of the measurement scale 20.

In the case of the arrangement of the scanning device 30 illustrated in FIG. 3, the spatial distribution of the light detected by the first arrangement 40.1 of photo sensors results from a superposition of the light reflected and/or scattered on the first track SP1 of the measurement scale 20, which propagates through the passage channel DK1 of the support body 50 (in accordance with the light ray LR1) and reaches the first arrangement 40.1 of photo sensors on a direct path (without being reflected or scattered on the support body 50), and the light reflected and/or scattered on the first track SP1 of the measurement scale 20, which propagates through the passage channel DK1 of the support body 50 (in accordance with the light ray LR2) and reaches the first arrangement 40.1 of photo sensors on an indirect path (as a result of being reflected or scattered on the support body 50).

In the present example, the first arrangement 40.1 photo sensors particularly may serve for determining the respectively traveled distance during a movement of the second linear guide body 3 relative to the first linear guide body 2 by evaluating periodic changes in the signals of the photo sensors of the first arrangement 40.1 during the movement of the second linear guide body 3.

The aforementioned superposition of the light reaching the first arrangement 40.1 on a direct path and the light reaching the first arrangement 40.1 on an indirect path complicates an evaluation of the signals generated by means of the first arrangement 40.1 of photo sensors. For example, the light that is reflected and/or scattered on a certain mirror area S of the first track SP1 of the measurement scale 20 and reaches the first arrangement 40.1 of photo sensors on a direct path through the passage channel DK1 may not be incident on the same photo sensor or the same group of multiple photo sensors of the first arrangement 40.1 of photo sensors as the light that is reflected and/or scattered on the same mirror area S of the first track SP1 of the measurement scale 20 and reaches the first arrangement 40.1 of photo sensors on an indirect path through the passage channel DK1. The aforementioned superposition of the light reaching the first arrangement 40.1 on a direct path and the light reaching the first arrangement 40.1 on an indirect path therefore can influence the magnitude of the respectively measurable changes in the signals of the individual photo sensors of the first arrangement 40.1 of photo sensors during a movement of the second linear guide body 3 and therefore significantly reduce the accuracy of a determination of the respective distance traveled by the second linear guide body 3.

In the case of the arrangement of the scanning device 30 illustrated in FIG. 3, the spatial distribution of the light detected by the second arrangement 40.2 of photo sensors results from a superposition of the light reflected and/or scattered on the second track SP2 of the measurement scale 20, which propagates through the passage channel DK1 of the support body 50 (in accordance with the light ray LR3) and reaches the second arrangement 40.2 of photo sensors on a direct path (without being reflected or scattered on the support body 50), and the light reflected and/or scattered on the second track SP2 of the measurement scale 20, which propagates through the passage channel DK1 of the support body 50 (in accordance with the light ray LR4) and reaches the second arrangement 40.2 of photo sensors on an indirect path (as a result of being reflected or scattered on the support body 50).

Due to the aforementioned superposition, light that is reflected and/or scattered on a certain mirror area (S1, S2, S3, S4, S5, S6, S7, S8, S9, S10, S11, S12, S13, S14 or S15) of the second track SP2 of the measurement scale 20 and reaches the second arrangement 40.2 of photo sensors on a direct path through the passage channel DK1 may not be incident on the same photo sensor or the same group of multiple photo sensors of the second arrangement 40.2 of photo sensors as the light that is reflected and/or scattered on the same mirror area of the second track SP2 of the measurement scale 20 and reaches the second arrangement 40.2 of photo sensors on an indirect path through the passage channel DK1. This effect has the disadvantage that, during a movement of the second linear guide body 3 relative to the first linear guide body 2, the respectively measurable changes in the signals of the photo sensors of the second arrangement 40.2 only indicate the respective position of the individual marking areas M1-M14 relatively inaccurately. This can significantly reduce the accuracy, with which the scanning device 30 should determine an absolute position of the second linear guide body 3 relative to the first linear guide body 2 by scanning the second track SP2 of the measurement scale 20.

According to the invention, the accuracy, with which a distance traveled by the second linear guide body can be determined by evaluating the signals of the individual photo sensors of the first arrangement 40.1 of photo sensors, or the accuracy, with which an absolute position of the second linear guide body 3 in relation to one of the markings M1-M14 of the second track SP2 of the measurement scale 20 can be determined by evaluating the signals of the individual photo sensors of the second arrangement 40.2 of photo sensors, is improved by implementing an antireflective body that can be arranged on the support body 50 and should largely prevent light reflected on the measurement scale 20 from reaching the first arrangement 40.1 of photo sensors or the second arrangement 40.2 of photo sensors of the light sensor 40 on an indirect path through the passage channel DK1 (as a result of being reflected or scattered on the support body 50).

Different embodiments of a corresponding antireflective body are described in greater detail below with reference to FIGS. 4A, 4B, 5A, 5B, 6A, 6B, 7 and 8.

FIGS. 4A, 4B, 5A, 5B, 6A and 6B show an antireflective body 60 (in the form of a first embodiment) and its implementation in the linear guiding device 1 or on the support body 50, respectively.

FIGS. 4A and 4B show the antireflective body 60 from different perspectives in a state, in which the antireflective body 60 is isolated and separated from the second linear guide body 3 or the support body 50, respectively.

According to FIGS. 4A and 4B, the antireflective body 60 is designed in the form of a component that has a first section 60.1 and at least one second section 60.2. It should be noted that the section 60.2 has no significant function with respect to the invention: as described in greater detail below, the formation of the second section 60.2 (optionally) makes it possible to achieve a simple arrangement of the antireflective body 60 on the support body 50, but is not suitable for influencing the light propagating through the passage channel DK1.

The antireflective body 60 or at least the first section 60.1 of the antireflective body 60 consists of a material that is suitable for absorbing light generated by means of the light source 35 and furthermore ensures that the first section 60.1 has a lower reflectivity for the light reflected and/or scattered on the at least one area of the measurement scale 20 than the sidewall SF1 of the passage channel DK1.

For example, a corresponding material may be a plastic. Suitable plastics are, among other things, polyoxymethylene (POM) or polypropylene carbonate (PPC) because these plastics ensure a high rigidity and a high stability and make it possible to cost-effectively manufacture the antireflective body 60 with high precision in the form of a molded part in an injection molding process. In order to ensure that the manufactured molded part has the highest absorption possible for the light generated by means of the light source 35, a colorant that is suitable for increasing the absorption of the light may be admixed to the plastic. For example, the choice of a suitable plastic and, if applicable, a suitable colorant makes it possible to provide the antireflective body 60 or the first section 60.1 of the antireflective body 60 in the form of a preferably black plastic part, which is suitable for completely absorbing the light generated by means of the light source 35 and therefore is not transparent for this light.

The antireflective body 60 is intended for being arranged on the support body 50 in such a way that the first section 60.1 of the antireflective body 60 extends through a first segment of the passage channel DK1 of the support body 50 along the lateral surface SF1 of the passage channel DK1 of the support body 50, and that a second segment of the passage channel DK1 of the support body 50 is present adjacent to the first section 60.1 of the antireflective body 60, wherein at least a portion of the light reflected or scattered on the first track SP1 or the second track SP2 of the measurement scale 20 can pass through said second segment of the passage channel DK1 on a direct path without being incident on the antireflective body 60 or on the lateral surface SF1 of the passage channel DK1. Since the first section 60.1 of the antireflective body 60 is suitable for absorbing the light generated by means of the light source 35, an arrangement of the first section 60.1 of the antireflective body 60 may cause another portion of the light reflected or scattered on the first track SP1 or the second track SP2 of the measurement scale 20, which is reflected and/or scattered in the direction of the sidewall SF1 of the passage channel DK1 of the support body 50, to be incident on the first section 60.1 of the antireflective body 60 and absorbable in this first section 60.1 of the antireflective body 60 such that it is prevented from being reflected on the sidewall SF1 of the passage channel DK1 of the support body 50 and/or prevented from reaching the light sensor 40 and being detectable by the light sensor 40 after a reflection on the sidewall SF1 of the passage channel DK1 of the support body 50.

FIGS. 4A and 4B show that the antireflective body 60 is shaped in such a way that the antireflective body 60 has a passage channel DK2 in the first section 60.1 of the antireflective body 60, wherein said passage channel extends along a longitudinal axis LA2 of the antireflective body 60 and is delimited radially to the longitudinal axis LA2 by a region of the antireflective body 60 that extends annularly around the longitudinal axis LA2.

FIGS. 4A and 4B likewise show that the antireflective body 60 has in the present example two second sections 60.2 that lie opposite of one another with respect to the longitudinal axis LA2 of the antireflective body and are respectively designed in the form of a shoulder RS, which extends radially to the longitudinal axis LA2 of the passage channel DK2 and is connected to the first section 60.1 of the antireflective body 60.

FIGS. 5A, 5B, 6A and 6B show the antireflective body 60 from different perspectives in a state, in which the antireflective body 60 is implemented on the second linear guide body 3 or on the support body 50, respectively.

In order to respectively implement the antireflective body 60 on the second linear guide body 3 or on the support body 50, the antireflective body 60 as a whole can be inserted into the first recess A1 of the support body 50 from the side of the support body 50, which is delimited by the first surface 50.1 of the support body 50, such that the first section 60.1 of the antireflective body 60 protrudes into the passage channel DK1 of the support body 50.

FIG. 5A shows the arrangement of the antireflective body 60 on the support body 50 from a perspective that allows a view into the first recess A1 of the support body 50 from the side of the support body 50, which is delimited by the first surface 50.1 of the support body 50. The arrangement of the two second sections 60.2 of the antireflective body 60 or the two shoulders RS in relation to the first surface 50.1 of the support body 50 particularly is visible in the view according to FIG. 5A. The scanning device is not present in the illustration according to FIG. 5A in order to allow a clear view of the two second sections 60.2 of the antireflective body 60 or the two shoulders RS and to ensure that the spatial extents of the two second sections 60.2 of the antireflective body 60 or the two shoulders RS are visible in their entirety. In addition, the second longitudinal guide body 3 or the support body 50 is respectively illustrated in FIG. 5A in such a way that a segment TB of the second linear guide body 3 or the support body 50 is removed in comparison with the illustration according to FIG. 1 (in the illustration according to FIG. 5A, this distant segment TB is delimited by the hatched surfaces illustrated in FIG. 5A).

FIG. 5B shows the arrangement of the antireflective body 60 on the support body 50 from a perspective that allows a view of the first section 60.1 of the antireflective body 60 from the side of the support body 50, which is delimited by the second surface 50.2 of the support body 50.

FIGS. 6A and 6B respectively show the arrangement of the antireflective body 60 in relation to the support body 50, the scanning device 30 and the measurement scale 20 (in the form of a cross section perpendicular to the X-direction and in the form of a longitudinal section along the X-direction).

In order to allow a placement of the antireflective body 60 on the support body 50 separately of the scanning device 30, the support body 50 has in the present example a second recess A2 on the first surface 50.1, wherein this second recess is formed adjacent to the first supporting surface AF1 in such a way that the second recess A2 extends longitudinally to the longitudinal axis LA1 of the passage channel DK1 of the support body 50 and is delimited in a region of the second recess A2 by a second supporting surface AF2, which extends radially to the longitudinal axis LA1 of the passage channel DK1 of the support body 50 (FIG. 6B).

When the antireflective body 60 is implemented on the support body 50, the antireflective body 60 is arranged in such a way that the two second sections 60.2 or the two shoulders RS of the antireflective body 60 extend radially to the longitudinal axis LA1 of the passage channel DK1 of the support body 50 and are brought in contact with the second supporting surface AF2 of the support body 50 (FIG. 6B). In this case, the first section 60.1 of the antireflective body 60 is arranged in the passage channel DK1 of the support body 50 in such a way that the first section 60.1 of the antireflective body 60 extends through a first segment TB1 of the passage channel DK1 of the support body 50 along the lateral surface SF1 of the passage channel DK1 of the support body 50 and the passage channel DK2 of the antireflective body 60 furthermore extends along the longitudinal axis LA1 of the passage channel DK1 of the support body 50. In the aforementioned arrangement of the antireflective body 60, the passage channel DK2 of the antireflective body 60 forms a second segment TB2 of the passage channel DK1 of the support body 50, wherein this second segment is arranged adjacent to the first section 60.1 of the antireflective body 60 and not filled by the antireflective body 60. Accordingly, light propagating along the longitudinal axis LA2 of the antireflective body 60 can respectively pass through the passage channel DK2 of the antireflective body 60 and the passage channel DK1 of the support body 50 without being affected by the antireflective body 60.

According to FIGS. 5B, 6A and 6B, the shape of the first section 60.1 of the antireflective body 60 is adapted to the shape of the passage channel DK1 of the support body 50 such that, when the antireflective body 60 is implemented on the support body 50, the first section 60.1 of the antireflective body 60 abuts on at least one or more regions of the lateral surface SF1 of the passage channel DK1 of the support body 50 with a radially outer lateral surface (in relation to the longitudinal axis LA2 of the antireflective body 60). The shape of the first section 60.1 of the antireflective body 60 may be chosen in such a way that the first section 60.1 of the antireflective body 60 can be inserted into the passage channel DK1 of the support body 50 and in the process clamped between different regions of the lateral surface SF1 of the passage channel DK1 of the support body 50 in order to hold the antireflective body 60 in a predetermined position in relation to the support body 50 with the least play possible. For this purpose the first section 60.1 of the antireflective body 60 may (as indicated in FIGS. 4A, 4B and 5B) have one or more elevations 61 on its radially outer lateral surface (in relation to the longitudinal axis LA2 of the antireflective body 60), wherein said elevations respectively extend outward radially to the longitudinal axis LA2 of the antireflective body 60. The aforementioned elevations 61 may be shaped in such a way that the first section 60.1 of the antireflective body 60 is, during an installation of the antireflective body 60 on the support body 50, brought in contact with the lateral surface SF1 of the passage channel DK1 of the support body 50 and in the process pressed against the lateral surface SF1 of the passage channel DK1 by means of the respective elevations 61 in such a way that the antireflective body 60 is held on the lateral surface SF1 of the passage channel DK1 by means of the respective elevations 61.

According to FIGS. 6A and 6B, the antireflective body 60 is in the present example implemented on the support body 50 in such a way that the first section 60.1 of the antireflective body 60 extends through a first segment TB1 of the passage channel DK1 of the support body 50 along the longitudinal axis LA1 of the passage channel DK1 of the support body 50 at least over part of the length of a longitudinal section of the passage channel DK1, wherein said longitudinal section is delimited by the first supporting surface AF1 for the scanning device 30 on a first end (located near the scanning device 30) and delimited by the second surface 50.2 of the support body 50 on a second end (located distant from the scanning device 30).

A comparison between the illustrations in FIGS. 3 and 6A indicates that the implementation of the antireflective body 60 on the support body 50 has no influence on an illumination of the measurement scale 20 by means of the light source 35 of the scanning device 30.

In the illustration according to FIG. 6A, it is assumed that the light source 35 is analogous to the illustration in FIG. 3 designed such that the light emitted by the light source 35 propagates along the longitudinal axis LA1 of the passage channel DK1 in such a way that the light propagating to the measurement scale 20 diverges in relation to the longitudinal axis LA1 of the passage channel DK1. In order to visualize these circumstances, the light that is emitted by the light source 35 and incident on the measurement scale 20 is represented by a pencil of four light rays in FIG. 6A, wherein said light rays are respectively identified by the reference symbols "LE1", "LE2", "LE3" and "LE4" and differ in that the light rays LE1, LE2, LE3 and LE4 are, starting from the light source 35, inclined in relation to the longitudinal axis LA1 of the passage channel DK1 with different angles and accordingly incident on the surface region Oxy of the first linear guide body 2, on which the measurement scale 20 is arranged, with different angles in relation to the longitudinal axis LA1 of the passage channel DK1. In the illustration according to FIG. 6A, it is assumed (analogous to the illustration in FIG. 3) that the light rays LE1 and LE2 are incident on the marking areas M and/or mirror areas S of the first track SP1 of the measurement scale 20 whereas the light rays LE3 and LE4 are incident on the marking areas M and/or mirror areas S of the second track SP2 of the measurement scale 20.

As indicated in FIG. 6A, the light rays LE1, LE2, LE3 and LE4 can propagate to the measurement scale 20 through the passage channel DK2 of the antireflective body 60 without being affected by the antireflective body 60 in order to thereby illuminate at least one area of the measurement scale 20.

Analogous to the illustration in FIG. 3, the light that is incident on different areas of the measurement scale 20 is in the case of the illustration in FIG. 6A typically reflected and/or scattered in different directions in relation to the longitudinal axis LA1 of the passage channel DK1.

In order to visualize these circumstances, it is assumed that the light represented by the light ray LE1 is in the illustration in FIG. 6A (analogous to the illustration in FIG. 3) reflected and/or scattered on the measurement scale 20 in such a way that the respectively reflected or scattered light is represented by a light ray identified by the reference symbol "LR1." Analogously, it is assumed that the light represented by the light rays LE2, LE3 and LE4 is reflected and/or scattered on the measurement scale 20 in such a way that the respectively reflected or scattered light is represented by light rays identified by the reference symbols "LR2", "LR3" and "LR4." As indicated in FIG. 6, the light represented by the light rays LR1, LR2, LR3 and LR4 respectively propagates - starting from the surface region Oxy of the first linear guide body 2 - with different angles relative to the longitudinal axis LA1 of the passage channel DK1.

As indicated in FIG. 6A, the light that is emitted by the light source 35 and incident on the first track SP1 of the measurement scale 20 in accordance with the light ray LE1 can be reflected and/or scattered on the first track SP1 of the measurement scale in such a way that the light reflected and/or scattered in accordance with the light ray LR1 illustrated in FIG. 6A can propagate through the passage channel DK2 of the antireflective body 60 and - starting from the first track SP1 of the measurement scale - reach the first arrangement 40.1 of photo sensors on a direct path (without being reflected on the sidewall SF1 of the passage channel DK1 of the support body 50 and without being affected by the antireflective body 60). The light propagating in accordance with the light ray LR1 therefore is suitable for being detected by means of the first arrangement 40.1 of photo sensors.

In contrast, the light that is emitted by the light source 35 and incident on the first track SP1 of the measurement scale 20 in accordance with the light ray LE2 is reflected and/or scattered on the first track SP1 of the measurement scale 20 in such a way that the light reflected and/or scattered in accordance with the light ray LR2 illustrated in FIG. 6A initially propagates through a region of the passage channel DK2 of the antireflective body 60 and is then incident on a region of the first section 60.1 of the antireflective body 60.

Since the first section 60.1 of the inventive antireflective body 60 consists of a material that is suitable for absorbing light generated by means of the light source 35 and furthermore ensures that the first section 60.1 has a lower reflectivity for the light reflected and/or scattered on the at least one area of the measurement scale 20 than the sidewall SF1 of the passage channel DK1, a corresponding design of the antireflective body 60 makes it possible to ensure that at least a relatively large portion of the light reflected and/or scattered on the first track SP1 of the measurement scale 20, which is incident on the first section 60.1 of the antireflective body 16 accordance with the light ray LR2 illustrated in FIG. 6A, is absorbed in the first section 60.1 of the antireflective body 60 and therefore prevented from being reflected on the sidewall SF1 of the passage channel DK1 of the support body 50, as well as prevented from reaching the first arrangement 40.1 of photo sensors and being detectable by means of the first arrangement 40.1 of photo sensors after a reflection on the sidewall SF1 of the passage channel DK1 of the support body 50.

As indicated in FIG. 6A, the light that is emitted by the light source 35 and incident on the second track SP2 of the measurement scale 20 in accordance with the light ray LE3 can be reflected and/or scattered on the second track SP2 of the measurement scale in such a way that the light reflected and/or scattered in accordance with the light ray LR3 illustrated in FIG. 6A can propagate through the passage channel DK2 of the antireflective body 60 and - starting from the second track SP2 of the measurement scale - reach the second arrangement 40.2 of photo sensors on a direct path (without being reflected on the sidewall SF1 of the passage channel DK1 of the support body 50 and without being affected by the antireflective body 60). The light propagating in accordance with the light ray LR3 therefore is suitable for being detected by means of the second arrangement 40.2 of photo sensors.

In contrast, the light that is emitted by the light source 35 and incident on the second track SP2 of the measurement scale 20 in accordance with the light ray LE4 is reflected and/or scattered on the second track SP2 of the measurement standard in such a way that the light reflected and/or scattered in accordance with the light ray LR4 illustrated in FIG. 6A initially propagates through a region of the passage channel DK2 of the antireflective body 60 and is then incident on a region of the first section 60.1 of the antireflective body 60.

Accordingly, a corresponding design of the antireflective body 60 makes it possible to ensure that at least a relatively large portion of the light reflected and/or scattered on the first track SP1 of the measurement standard 20, which is incident on the first section 60.1 of the antireflective body 60 in accordance with the light ray LR4 illustrated in FIG. 6A, is absorbed in the first section 60.1 of the antireflective body 60 and therefore prevented from being reflected on the sidewall SF1 of the passage channel DK1 of the support body 50, as well as prevented from reaching the second arrangement 40.2 of photo sensors and from being detectable by means of the second arrangement 40.2 of photo sensors after a reflection on the sidewall SF1 of the passage channel DK1 of the support body 50.

As a supplement to the aforementioned comments regarding the effect of the antireflective body 60 on the light corresponding to the light rays LR2 and LR4, it should be noted that a relatively small portion of the light reflected and/or scattered on the first track SP1 of the measurement standard 20, which is incident on a region of the first section 60.1 of the antireflective body 60 in accordance with the light ray LR2 illustrated in FIG. 6A, can potentially be reflected and/or scattered on the surface of the first section 60.1 of the antireflective body 60 in such a way that a portion of this light being reflected and/or scattered on the surface of the first section 60.1 of the antireflective body 60 could reach the first arrangement 40.1 of photo sensors and possibly be detectable by means of the first arrangement 40.1 of photo sensors. Analogously, a relatively small portion of the light reflected and/or scattered on the second track SP2 of the measurement standard 20, which is incident on a region of the first section 60.1 of the antireflective body 60 in accordance with the light ray LR4 illustrated in FIG. 6A, can potentially be reflected and/or scattered on the surface of the first section 60.1 of the antireflective body 60 in such a way that a portion of this light being reflected and/or scattered on the surface of the first section 60.1 of the antireflective body 60 could reach the second arrangement 40.2 of photo sensors and possibly be detectable by means of the second arrangement 40.2 of photo sensors. The intensity of the light that is reflected and/or scattered on the surface of the first section 60.1 of the antireflective body 60 and could reach the first arrangement 40.1 of photo sensors or the second arrangement 40.2 of photo sensors in this way can be substantially reduced and minimized with a suitable design of the surface of the first section 60.1 of the antireflective body 60. For this purpose, it would be possible, for example, to design regions of the surface of the first section 60.1 of the antireflective body 60, on which the light reflected and/or scattered on the measurement standard may be incident, with a dull finish that has a predetermined roughness (e.g. a mean roughness index Ra in the range 0.8 µm < Ra < 4.5 µm).

FIG. 7 shows an antireflective body 60A (in the form of a second embodiment of an inventive antireflective body) and its implementation in the linear guiding device 1 or on the support body 50, respectively.

The antireflective body 60A resembles the antireflective body 60 illustrated in FIGS. 4A, 4B, 5A, 5B, 6A and 6B insofar as the antireflective body 60A has a first section 60.1 that essentially corresponds to the first section 60.1 of the antireflective body 60 with respect to its function, its physical structure and its material properties. Accordingly, the antireflective body 60A is shaped in such a way that the antireflective body 60A has a passage channel DK2 in the first section 60.1, wherein said passage channel extends along a longitudinal axis LA2 of the antireflective body 60A and is delimited radially to the longitudinal axis LA2 by a region of the antireflective body 60A extending annularly around the longitudinal axis LA2.

The antireflective body 60A particularly differs from the antireflective body 60 in that the antireflective body 60A is fastened on the scanning device 30. In this case, the scanning device and the antireflective body 60A form a unit that can be moved and implemented on the support body 50 as a whole. FIG. 7 shows that the scanning device 30 is in the present example implemented on the support body 50 in such a way that the scanning device 30 is brought in contact with the first supporting surface AF1 of the support body 50. The antireflective body 60A is fastened on the scanning device 30 in such a way that, when the scanning device 30 is implemented on the first supporting surface AF1 of the support body 50, the first section 60.1 of the antireflective body 60A extends through a first segment TB1 of the passage channel DK1 of the support body 50 along the lateral surface SF1 of the passage channel DK1 of the support body 50 (analogous to the arrangement of the first section 60.1 of the antireflective body 60 according to FIGS. 6A and 6B). The first section 60.1 of the antireflective body 60A may in this case be arranged at a distance from the lateral surface SF1 of the passage channel DK1 of the support body 50.

FIG. 8 shows an antireflective body 60B (in the form of a third embodiment of an inventive antireflective body) and its implementation in the linear guiding device 1 or on the support body 50, respectively.

The antireflective body 60B resembles the antireflective body 60 illustrated in FIGS. 4A, 4B, 5A, 5B, 6A and 6B insofar as the antireflective body 60B has a first section 60.1 and one or more second sections 60.2, wherein the first section 60.1 of the antireflective body 60B essentially corresponds to the first section 60.1 of the antireflective body 60 with respect to its function, its physical structure and its material properties, and wherein a second section 60.2 of the antireflective body 60B essentially corresponds to a second section 60.2 of the antireflective body 60 with respect to its function.

Accordingly, the antireflective body 60B is shaped in such a way that the antireflective body 60B has a passage channel DK2 in the first section 60.1, wherein said passage channel extends along a longitudinal axis LA2 of the antireflective body 60B and is delimited radially to the longitudinal axis LA2 by a region of the antireflective body 60B extending annularly around the longitudinal axis LA2. In the present example, the antireflective body 60B therefore has two second sections 60.2 that lie opposite of one another with respect to the longitudinal axis LA2 of the antireflective body 60B and are respectively designed in the form of a shoulder RS, which extends radially to the longitudinal axis LA2 of the passage channel DK2 and is connected to the first section 60.1 of the antireflective body 60B.

The antireflective body 60B particularly differs from the antireflective body 60 in that the scanning device 30 is fastened on the antireflective body 60B. In this case, the scanning device and the antireflective body 60A form a unit that can be moved and implemented on the support body 50 as a whole. FIG. 8 shows that a third supporting surface AF3 for the scanning device 30, which extends radially to the longitudinal axis LA1 of the passage channel DK1 of the support body 50, is formed on the second sections 60.2 of the antireflective body 60B in a region of the second section 60.2 of the antireflective body 60B located distant from the first supporting surface AF1 of the support body 50.

The scanning device 30 is placed on the antireflective body 60B in such a way that the scanning device 30 is in contact with the third supporting surface AF3 and held in a predetermined position in relation to the antireflective body 60B by means of the third supporting surface AF3. In the present example, the antireflective body 60B has a recess A3 in the region of the second sections 60.2 of the antireflective body 60B, wherein this recess A3 is designed in such a way that it extends longitudinally to the longitudinal axis LA2 of the passage channel DK2 of the antireflective body 60B and is delimited by the third supporting surface AF3. The scanning device therefore can be implemented on the antireflective body 60B in such a way that the scanning device 30 is received in the recess A3 when it is brought in contact with the third supporting surface AF3.

FIG. 8 shows that the antireflective body 60B is in the present example implemented on the support body 50 in such a way that the second section 60.2 of the antireflective body 60B is brought in contact with the first supporting surface AF1 of the support body 50 and the first section 60.1 of the antireflective body 60B extends through a first segment TB1 of the passage channel DK1 of the support body 50 along the lateral surface SF1 of the passage channel DK1 of the support body 50 (analogous to the arrangement of the first section 60.1 of the antireflective body 60 according to FIGS. 6A and 6B). The first section 60.1 of the antireflective body 60B may in this case be arranged at a distance from the lateral surface SF1 of the passage channel DK1 of the support body 50.

With respect to the antireflective bodies 60, 60A and 60B, the first section 60.1 respectively forms a structure that extends annularly around the longitudinal axis LA2 and delimits a passage channel DK2 extending along the longitudinal axis LA2 radially outward in relation to the longitudinal axis LA2. However, the first section 60.1 may in the context of the invention also have a different shape. For example, it is not necessary that the first section 60.1 extends annularly around the longitudinal axis LA2 along a closed line. Depending on the spatial position of the light source 35 and/or the photo sensors of the light sensor 40 in relation to the support body 50, it may suffice that the first section 60.1 of the antireflective body only extends in the passage channel DK1 of the support body 50 along part of the circumference of the lateral surface SF1 of the passage channel DK1 and/or over part of the length of the passage channel DK1 along the longitudinal axis LA1 of the passage channel DK1.

Although only a few embodiments of the present invention have been shown and described, it is to be understood that many changes and modifications may be made thereunto without departing from the spirit and scope of the invention.

What is claimed is:

1. A linear guiding device (1), comprising:
a first linear guide body (2) and a second linear guide body (3), wherein the second linear guide body (3) is linearly movable relative to the first linear guide body (2) in a first direction (X); and
an optical linear measuring system (10) for detecting a position of the second linear guide body (3) in relation to the first linear guide body (2);
wherein the optical linear measuring system (10) comprises:
a measurement scale (20) that is arranged stationarily in relation to the first linear guide body (2) and has a plurality of markings (M; M1-M14) arranged behind one another in a row; and
a scanning device (30) for optically scanning the markings (M; M1-M14) of the measurement scale (20), which scanning device (30) is arranged stationarily in relation to the second linear guide body (3);
wherein the scanning device (30) comprises:
a light source (35) for generating light (LE1, LE2) in order to illuminate at least one area of the measurement scale (20) comprising at least one of the markings (M; M1-M14), wherein the measurement scale is designed for reflecting and/or scattering incident light (LE1, LE2, LE3, LE4) generated by the light source; and
a light sensor (40, 40.1, 40.2) for detecting light (LR1, LR2) reflected and/or scattered on the at least one area of the measurement scale (20); and
a support body (50) for the light sensor (40, 40.1, 40.2), wherein this support body (50) is arranged stationarily in relation to the second linear guide body (3) and has a passage channel (DK1) that is delimited by a lateral surface (SF1) extending along a longitudinal axis (LA1) of the passage channel (DK1), and wherein said passage channel extends between the light sensor (40, 40.1, 40.2) and the measurement scale (20) in such a way that light (LR1, LR2, LR3, LR4) reflected and/or scattered on the at least one area of the measurement scale (20) is enabled to reach the light sensor (40, 40.1, 40.2) through the passage channel (DK1) and be detected by means of the light sensor (40, 40.1, 40.2);
wherein
an antireflective body (60, 60A, 60B) is arranged on the support body (50), wherein the antireflective body (60, 60A, 60B) has a first section (60.1), which comprises a material that is suitable for absorbing light that is enabled to be generated by means of the light source (35) and furthermore ensures that the first section (60.1) has a lower reflectivity for the light reflected and/or scattered on the at least one area of the measurement scale (20) than the sidewall (SF1) of the passage channel (DK1),
wherein the first section (60.1) of the antireflective body (60, 60A, 60B) extends through a first segment (TB1) of the passage channel (DK1) of the support body (50) along the lateral surface (SF1) of the passage channel (DK1) of the support body (50) in such a way that a second segment (TB2) of the passage channel (DK1) of the support body (50) is present adjacent to the first section (60.1) of the antireflective body (60, 60A, 60B)
such that at least a portion (LR1, LR3) of the light (LR1, LR2, LR3, LR4) reflected and/or scattered on the at least one area is enabled to directly pass through the second segment (TB2) of the passage channel (DK1) of the support body (50) and reach the light sensor (40, 40.1, 40.2) without being reflected on the sidewall (SF1) of the passage channel (DK1) of the support body (50) and without being affected by the antireflective body (60, 60A, 60.B) in order to be detectable by means of the light sensor (40, 40.1, 40.2), and
wherein another portion (LR2, LR4) of the light (LR1, LR2, LR3, LR4) reflected and/or scattered on the at least one area of the measurement scale (20), which is reflected and/or scattered in the direction of the sidewall (SF1) of the passage channel (DK1) of the support body (50), is enabled to be absorbed by the antireflective body (60, 60A, 60B) and therefore is prevented from being reflected on the sidewall (SF1) of the passage channel (DK1) of the support body (50) and/or from reaching the light sensor (40, 40.1, 40.2) and being detectable by means of the light sensor (40, 40.1, 40.2) after a reflection on the sidewall (SF1) of the passage channel (DK1) of the support body (50).

2. The linear guiding device (1) according to claim 1, wherein the support body (50) is an integral component of the second linear guide body (3).

3. The linear guiding device (1) according to claim 1, wherein the antireflective body (60, 60A, 60B) has a passage channel (DK2) in the first section (60.1) of the antireflective body (60, 60A, 60B), wherein said passage channel extends through the second segment (TB2) of the passage channel (DK1) of the support body (50) along the longitudinal axis (LA1) of the passage channel (DK1) of the support body (50).

4. The linear guiding device (1) according to claim 1, wherein the support body (50) has a first surface (50.1) and a second surface (50.2) lying opposite of the first surface (50.1), wherein the second surface (50.2) has a shorter distance in relation to the measurement scale (20) than the first surface (50.1), wherein a first supporting surface (AF1) extending radially to the longitudinal axis (LA1) of the passage channel (DK1) of the support body (50) is formed on the first surface (50.1), and wherein the first supporting surface (AF1) serves for supporting the scanning device (30) or the antireflective body (60B).

5. The linear guiding device (1) according to claim 4, wherein the support body (50) has a first recess (A1) on the first surface (50.1), wherein the first recess extends longitudinally to the longitudinal axis (LA1) of the passage channel (DK1) of the support body (50), and
wherein the first supporting surface (AF1) is formed in the first recess (A1) such that the first recess (A1) is delimited by the first supporting surface (AF1).

6. The linear guiding device (1) according to claim 4, wherein the support body (50) has a second recess (A2) on the first surface (50.1), wherein this second recess is formed adjacent to the first supporting surface (AF1) in such a way that the second recess (A2) extends longitudinally to the longitudinal axis (LA1) of the passage channel (DK1) of the support body (50) and is delimited by a second supporting surface (AF2) in a region of the second recess (A2), and wherein this second supporting surface extends radially to the longitudinal axis (LA1) of the passage channel (DK1) of the support body (50).

7. The linear guiding device (1) according to claim 6, wherein the antireflective body (60) has at least one second section (60.2) that is designed in the form of a shoulder (RS) extending radially to the longitudinal axis (LA1) of the passage channel (DK1) of the support body (50), and
wherein the antireflective body (60) is or is configured to be placed on the support body (50) in such a way that the first section (60.1) of the antireflective body (60) is arranged in the first segment (TB1) of the passage channel (DK1) of the support body (50) and the at least one second section (60.2) of the antireflective body (60) is brought in contact with the second supporting surface (AF2) of the support body (50).

8. The linear guiding device (1) according to claim 4, wherein the scanning device (30) is or is configured to be placed on the support body (50) in such a way that the scanning device (30) is brought in contact with the first supporting surface (AF1) of the support body (50).

9. The linear guiding device (1) according to claim 4, wherein the antireflective body (60A) is fastened on the scanning device (30), and
wherein the scanning device (30) is or is configured to be placed on the support body (50) in such a way that the scanning device (30) is brought in contact with the first supporting surface (AF1) of the support body (50) and the first section (60.1) of the antireflective body (60A) is arranged in the first segment (TB1) of the passage channel (DK1) of the support body (50).

10. The linear guiding device (1) according to claim 4, wherein the antireflective body (60B) has at least one second section (60.2) that is designed in the form of a shoulder extending radially to the longitudinal axis (LA1) of the passage channel (DK1) of the support body (50), and
wherein the antireflective body (60B) is or is configured to be placed on the support body (50) in such a way that the second section of the antireflective body (60B) is brought in contact with the first supporting surface (AF1) of the support body (50) and the first section (60.1) of the antireflective body (60B) is arranged in the first segment (TB1) of the passage channel (DK1) of the support body (50).

11. The linear guiding device (1) according to claim 10, wherein a third supporting surface (AF3) for the scanning device (30) extending radially to the longitudinal axis (LA1) of the passage channel (DK1) of the support body (50) is formed on the second section (60.2) of the antireflective body (60B) in a region of the second section (60.2) of the antireflective body (60B) located distant from the first supporting surface (AF1) of the support body (50), and
wherein the scanning device (30) is or is configured to be placed on the antireflective body (60B) in such a way that the scanning device (30) is in contact with the third supporting surface (AF3) and is or is configured to be held in a predetermined position in relation to the antireflective body (60B) by means of the third supporting surface (AF3).

12. The linear guiding device (1) according to claim 1, wherein the antireflective body (60, 60A, 60B) is made of a plastic material.

13. The linear guiding device (1) according to claim 12, wherein a colorant is dispersed in the plastic material, and wherein said colorant is suitable for absorbing light that is enabled to be generated by means of the light source (35).

14. The linear guiding device (1) according to claim 1, wherein the antireflective body (60, 60A, 60B) has a surface that has a roughness with a mean roughness index Ra in the range 0.8 µm < Ra < 4.5 µm at least in a region that is accessible for the light (LR2) reflected and/or scattered on the at least one area of the measurement scale (20).

15. The linear guiding device (1) according to claim 1, wherein the shape of the first section (60.1) of the antireflective body (60, 60A, 60B) is adapted to the shape of the passage channel (DK1) of the support body (50) such that the first section (60.1) of the antireflective body (60, 60A, 60B) is configured to be inserted into the passage channel (DK1) of the support body (50) and clamped between different regions of the lateral surface (SF1) of the passage channel (DK1) of the support body (50) in order to hold the antireflective body (60, 60A, 60B) in a predetermined position in relation to the support body (50).

16. The linear guiding device (1) according to claim 1, wherein the first linear guide body (2) is designed in the form of a guide rail extending linearly in the first direction (X) and the second linear guide body (3) is designed in the form of a guide carriage guided on the guide rail.

17. The linear guiding device (1) according to claim 1, wherein the second linear guide body is designed in the form of a guide rail extending linearly in the first direction (X) and the first linear guide body is designed in the form of a guide carriage guided on the guide rail.
